(19) United States
(12) Patent Application Publication
(10) Pub. No.: US 2010/0101356 A1
(43) Pub. Date: Apr. 29, 2010

(54) Remotely controlled mobile robot in-line robot arm and end effector mechanism

(76) Inventor: Scott R. Albin, Carlisle, MA (US)

Correspondence Address: Iandiorio Teska & Coleman, 260 Bear Hill Road, Waltham, MA, 02451, US

(21) Appl. No.: 12/288,943

(22) Filed: Oct. 24, 2008

(51) Int. Cl. B25J 15/08

(52) U.S. Cl. 74/490.03; 901/1; 901/23; 901/31

(57) ABSTRACT

A robot arm end effector mechanism for a mobile, remotely controlled robot includes an arm housing; an end effector bearing sleeve rotatable relative to the arm housing; a roll motor unit, fixed to the arm housing and having a roll drive axis, for rotating said bearing sleeve; and an end effector motor unit having an end effector drive axis and being fixed to and rotatable with the bearing sleeve for operating the end effector.

### FIELD OF THE INVENTION

This invention relates to a mobile, remotely controlled robot and more particularly to such a mobile, remotely controlled robot with an improved, in-line robot arm and end effector mechanism.

### BACKGROUND OF THE INVENTION

Mobile, remotely controlled robots are becoming increasingly popular for use by the military, SWAT units, and police and fire departments. The applicants' TALON® robot, for example, includes an arm with an end effecter, several cameras, several antennas, and a deployable mast. Frequently the end effector is a gripper, e.g. a pair of jaws that can be opened and closed on command to grasp objects such as debris, hazardous material, unexploded ordinance and the like. The larger robots even have the capability to grip an injured, downed, person by some personal paraphernalia such as a shirt collar and drag them out of harm's way to safety. Presently, the upper arm of the robot has an end effector mounted on its distal end eccentric to its axis so the end effector actually orbits the upper arm end. Such a construction makes for a more complicated drive system for the eccentrically mounted end effector which contributes to larger size and weight as well as increased cost. Another shortcoming revealed in operational situations is the added difficultly for the human operator in aiming or positioning the end effector in its eccentric orbit.

### SUMMARY OF THE INVENTION

It is therefore an object of this invention to provide an improved mobile, remotely controlled robot.

It is a further object of this invention to provide such an improved mobile, remotely controlled robot which has a more compact, lighter, smaller and lower cost robot arm end effector mechanism.

It is a further object of this invention to provide such an improved mobile, remotely controlled robot which is easier for the human operator to aim or position.

It is a further object of this invention to provide such an improved mobile, remotely controlled robot which orients the end effector in line with the robot arm.

The invention results from the realization that an improved robot arm end effector mechanism for a mobile, remotely controlled robot which is smaller, more compact, less complex and easier to operate can be achieved with a roll motor unit fixed to the robot arm housing for rotating an end effector bearing sleeve and an end effector motor unit rotatable with the bearing sleeve for operating the end effector.

The subject invention, however, in other embodiments, need not achieve all these objectives and the claims hereof should not be limited to structures or methods capable of achieving these objectives.

This invention features a robot arm end effector mechanism for a mobile, remotely controlled robot including an arm housing, an end effector bearing sleeve rotatable relative to the arm housing, a roll motor unit, fixed to the arm housing and having a roll drive axis, for rotating the bearing sleeve, and an end effector motor unit having an end effector drive axis and being fixed to and rotatable with the bearing sleeve for operating the end effector.

In a preferred embodiment the bearing sleeve may be rotatable inside of the arm housing. The bearing sleeve may be coaxial with the arm housing. The roll motor unit may be within the arm. The end effector motor unit may be within the bearing sleeve. Each motor unit may include a motor and a gear reducer. The bearing sleeve and arm housing may be elongate cylinders. The axes of the motor units may be parallel. The axes of the motor units may be coaxial. The robot arm end effector mechanism may further include a slip ring unit interconnected between the arm housing and bearing sleeve for communicating electric power to the end effector motor unit. The end effector may be a gripper. The gripper may include two fingers each driven by a gear and a drive gear for driving the gears and the end effector motor unit may drive the drive gear.

This invention also features a robot arm end effector mechanism for a mobile, remotely controlled robot including a robot arm housing, an end effector bearing sleeve within, coaxial with and rotatable relative to the arm housing, a roll motor unit within and fixed to the arm housing and having a roll drive axis for rotating the bearing sleeve, and an end effector motor unit within and fixed to the bearing sleeve and having an end effector drive axis for operating the end effector; the roll drive axis and end effector drive axis are coaxial.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional view of a conventional mobile, remotely controlled robot including lower and upper arms and an end effector;

FIG. 2 is a diagrammatic, three dimensional exploded view of an upper arm end effector mechanism according to this invention;

FIG. 3 is a schematic, side, cross-sectional elevation of the arm end effector mechanism of FIG. 2;

FIG. 4 is a schematic, top, cross-sectional view of one example of an end effector that can be used;

FIG. 5 is a diagrammatic, three dimensional, exploded view of the roll motor unit of FIGS. 2 and 3;

FIG. 6 is a diagrammatic, three dimensional, exploded view of the end effector motor unit of FIGS. 2 and 3; and

FIG. 7 is a diagrammatic, three dimensional, exploded view of the slip ring assembly of FIGS. 2 and 3;

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

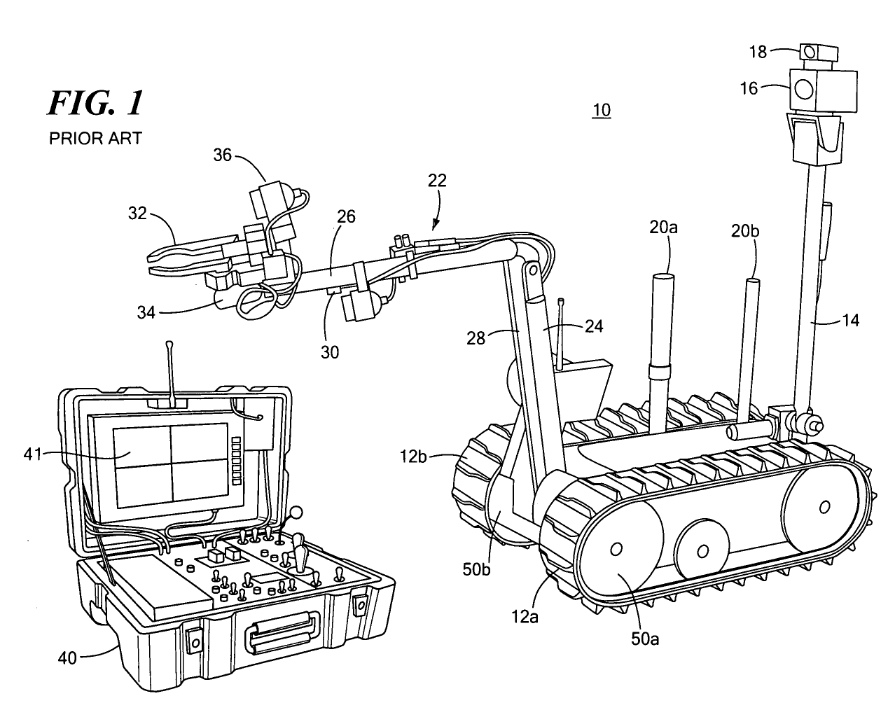

FIG. 1 shows a mobile, remotely controlled robot 10 driven by tracks 12a and 12b in accordance with one particular example of a robot in accordance with the subject invention. Robot 10 includes deployable mast 14, camera 16, light 18, antennas 20a and 20b, and arm assembly 22. Arm assembly 22 includes lower arm 24 and upper arm 26. Lower arm 24 is able to pitch up and down but it does not turn. Upper arm 26 pitches with respect to lower arm 24 and is driven by chain drive 28 extending along lower arm 24. Microphone 30 is on upper arm 26 as is end effector 32 which rotates via wrist 34. Camera 36 is typically aimed at end effector 32. Operator control unit 40 is used to wirelessly control robot 10 as is known in the art. The various images captured by the cameras of the robot may be displayed on view screen 41.

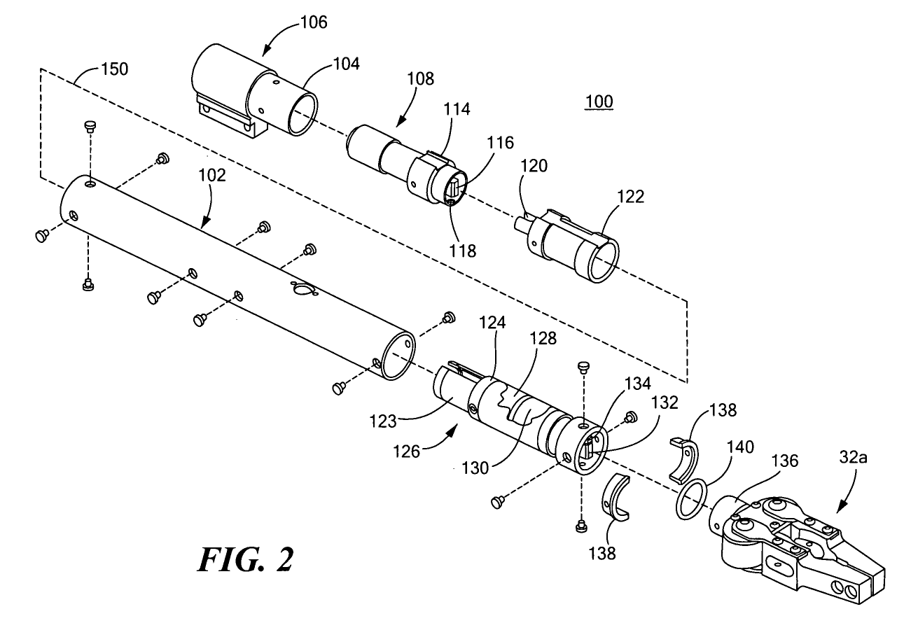

The robot arm—end effector mechanism 100, FIG. 2, including upper arm 26 and end effector 32a are shown to more advantage in the schematic three dimensional exploded view of FIG. 2. There upper arm tube 102 fits over the reduced section 104 of upper elbow sleeve 106. Roll motor unit 108 includes motor 110, gear reducer 112, and roll motor mount 114. Output shaft 116 of roll motor unit 108 includes a key 118 which engages with yoke 120 in slip ring sleeve 122, all of which are disposed inside of upper arm tube 102. At the distal end of upper arm tube 102 is bearing sleeve 124 which includes end effector motor unit 126 including motor 128 and gear reducer 130. The output shaft 132 contains a key 134 which engages with a drive gear in end effector 32a. End effector 32a mounts to end effector motor unit 126 through engagement of its collar 136. Retainer rings 138 and sealing O-ring 140 retain and seal motor unit 126 into arm 102. Note that the roll drive unit 108, upper arm tube 102, bearing sleeve 124, end effector motor unit 126, and end effector 32a are all coaxial on axis 150.

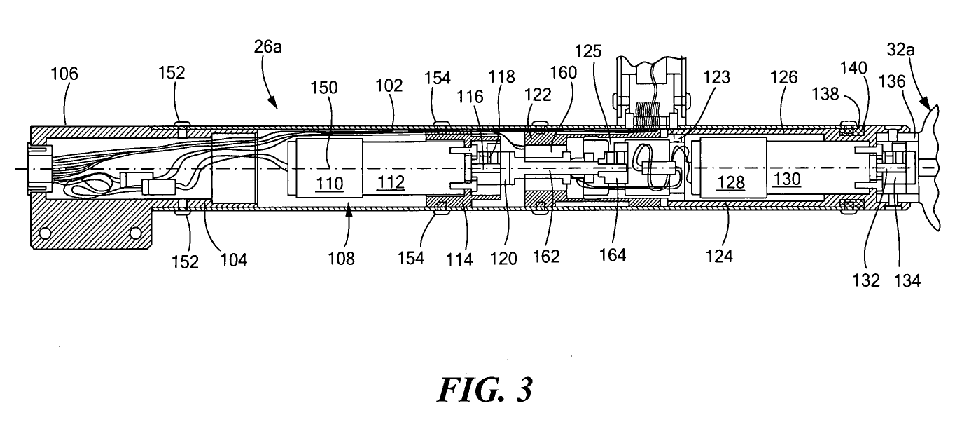

The structure can perhaps be better understood by reference to FIG. 3, which is a cross sectional view showing that upper elbow sleeve 106 supports upper arm tube 102 in a fixed relationship via screws 152 and that roll motor unit 108 including motor 10 and gear reducer 112 are also fixed to upper arm tube 102 by means of roll motor mount 114 through screws 154. Slip ring 160 is mounted within slip ring sleeve 122 about shaft 162 which extends from yoke 120. Shaft 162 contains key 164 which fixes it to roll drive sleeve 123 by engaging slot 125 in roll drive sleeve 123. Roll drive sleeve 123 is fixed to roll bearing sleeve 124 such as by screws 170 so that roll drive sleeve when rotated by the roll motor unit 108 through shafts 116 and 162 will rotate the entire bearing sleeve 124 containing end effector motor unit 126 including motor 128 and gear reducer 130. Again it can be seen that all of the components, roll motor unit 108, end effector motor unit 124, upper arm tube 102, and end effector 32a are all coaxial about the axis 150.

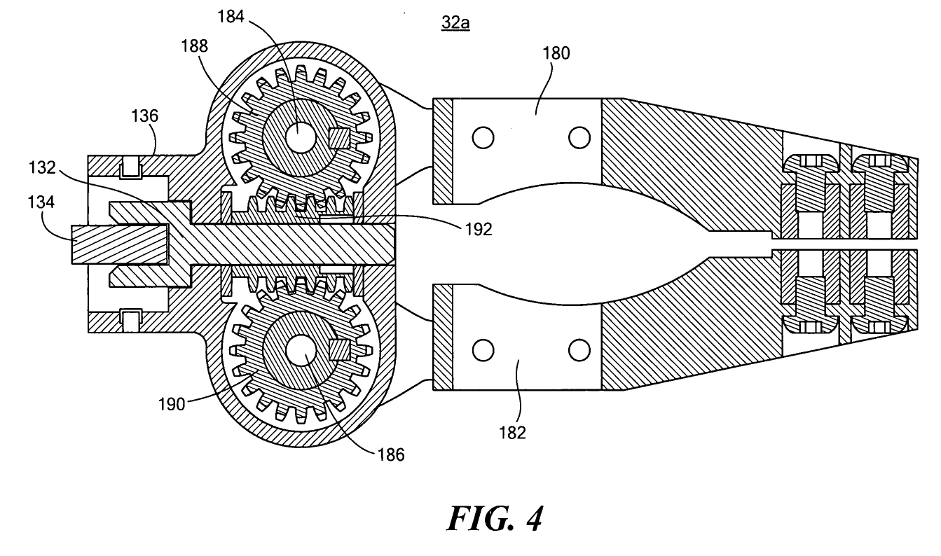

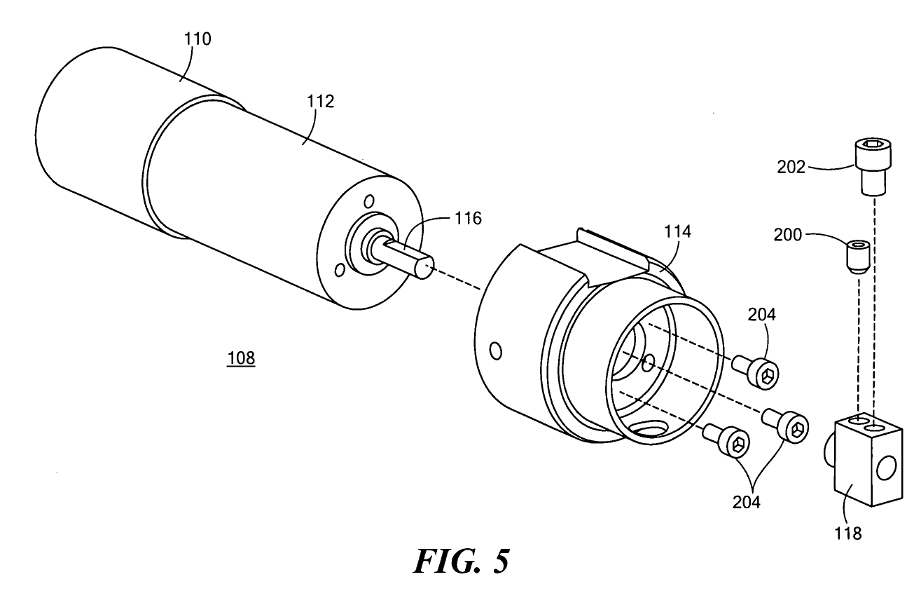

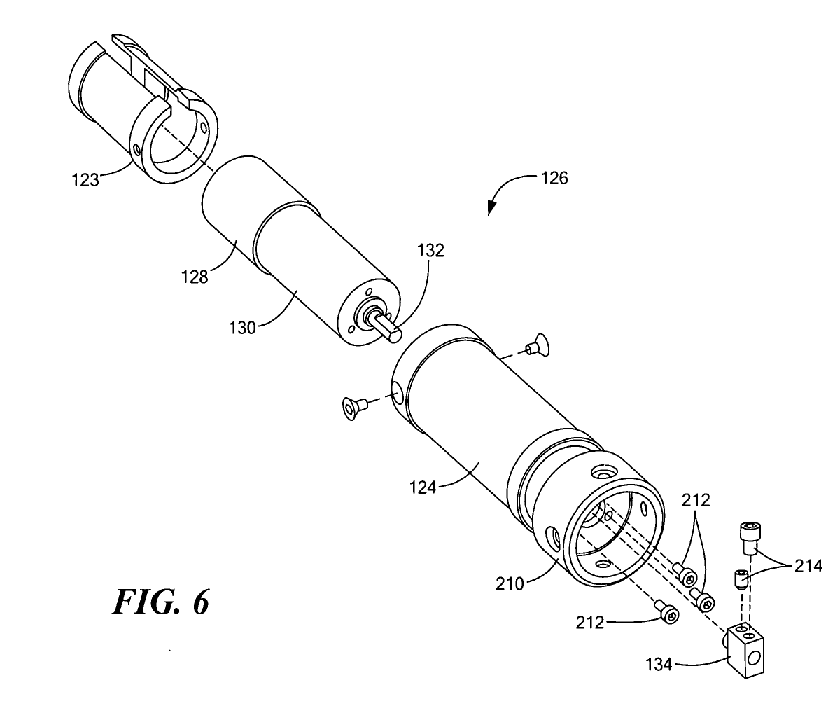

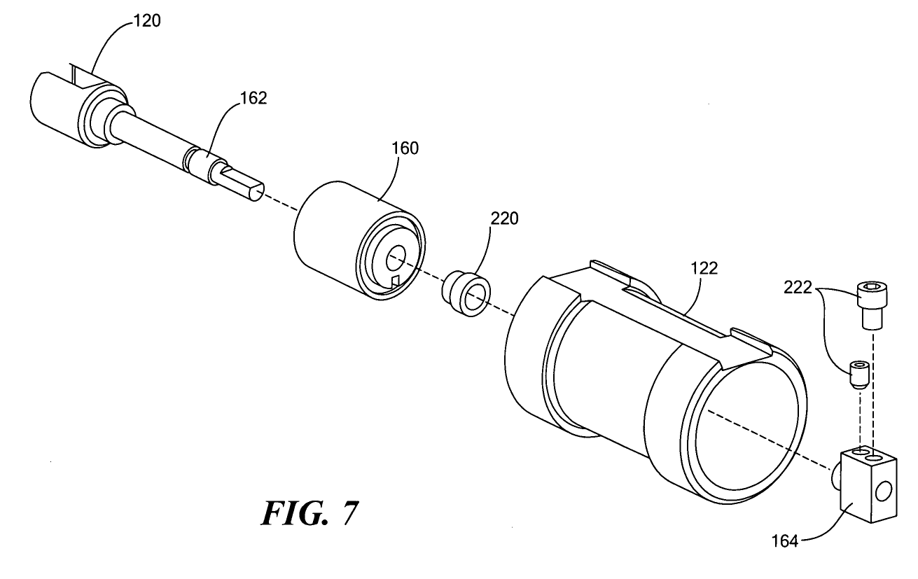

End effector 32a, FIG. 4, may be any type of device required to perform the robot's designated tasks. In this particular example, end effector 32a is implemented with a gripper having fingers 180, 182 which are fixed to pivot pins 184, 186 that rotate with, for example, worm gears 188, 190 driven by a drive gear such as worm 192 that engages with the key 134 and output shaft 132 of end effector motor unit 126. Roll motor unit 108 is shown in greater detail in FIG. 5 including roll motor 110, gear reducer 112, output shaft 116, and roll motor mount 114. Key 118 has key lock screws 200 and 202 and mounting screws 204 for fixing roll motor unit 108 to roll motor mount 114. End effector motor unit 126, FIG. 6, is shown with the roll drive sleeve 123, motor 128, and gear reducer 130 inside of bearing sleeve 124. Mounting collar 210 is part of bearing sleeve 124 and screws 212, for example, may fix reducer 130 to 124. Set screws 214 fix key 134 to shaft 132. Slip ring 160 details are shown more specifically in FIG. 7 where roll shaft 162 mounts through slip ring 160 and slip ring spacer 220 while slip ring 160 mounts inside of slip ring mount 122. Key 164 is fixed to shaft 162 by set screws 222.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A robot arm end effector mechanism for a mobile, remotely controlled robot comprising:
an arm housing;
an end effector bearing sleeve rotatable relative to said arm housing;
a roll motor unit, fixed to said arm housing and having a roll drive axis, for rotating said bearing sleeve; and
an end effector motor unit having an end effector drive axis and fixed to and rotatable with said bearing sleeve for operating said end effector.

2. The robot arm end effector mechanism of claim 1 in which said bearing sleeve is rotatable inside of said arm housing.

3. The robot arm end effector mechanism of claim 1 in which said bearing sleeve is coaxial with said arm housing.

4. The robot arm end effector mechanism of claim 1 in which said roll motor unit is within said arm.

5. The robot arm end effector mechanism of claim 1 in which said end effector motor unit is within said bearing sleeve.

6. The robot arm end effector mechanism of claim 1 in which each motor unit includes a motor and a gear reducer.

7. The robot arm end effector mechanism of claim 1 in which said bearing sleeve and arm housing are elongate cylinders.

8. The robot arm end effector mechanism of claim 1 in which said axes of said motor units are parallel.

9. The robot arm end effector mechanism of claim 1 in which said axes of said motor units are coaxial.

10. The robot arm end effector mechanism of claim 1 further including a slip ring unit interconnected between said arm housing and bearing sleeve for communicating electric power to said end effector motor unit.

11. The robot arm end effector mechanism of claim 1 in which said end effector is a gripper.

12. The robot arm end effector mechanism of claim 11 in which said gripper includes two fingers each driven by a gear and a drive gear for driving said gears and said end effector motor unit drives said drive gear.

13. A robot arm end effector mechanism for a mobile, remotely controlled robot comprising:
a robot arm housing;
an end effector bearing sleeve within, coaxial with and rotatable relative to said arm housing;
a roll motor unit within and fixed to said arm housing and having a roll drive axis for rotating said bearing sleeve; and
an end effector motor unit within and fixed to said bearing sleeve and having an end effector drive axis for operating said end effector; said roll drive axis and end effector drive axis being coaxial.
